(19) United States
(12) Patent Application Publication
(10) Pub. No.: US 2008/0291783 A1
(43) Pub. Date: Nov. 27, 2008

(54) Seismic data acquisition

(75) Inventors: Steven William Wilcox, Kinross (GB); John Christopher Whelan, Ayrshire (GB); Jonathan Alexander, Larbert (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Vibration Technology Limited, Larbert (GB)

(21) Appl. No.: 12/151,519

(22) Filed: May 7, 2008

(30) Foreign Application Priority Data
May 23, 2007 (EP) 07252123.0

(51) Int. Cl. G01V 1/22; G01V 1/24

(52) U.S. Cl. 367/76

(57) ABSTRACT

A seismic system uses a plurality of remote acquisition units in each of which geophone signals in digital form are temporarily stored in a buffer for near-real-time transmission by a transmitter. The whole of the digital data is also stored in a bulk store within the acquisition unit, from which it can be retrieved and transmitted under control of signals received by a receiver. This allows a central control unit to cause lost or low quality data to be retransmitted in a flexible manner.

This relates to seismic surveying, and in particular to a method of acquiring seismic data, and to an acquisition unit and system for use with such a method.

### BACKGROUND

In land seismic surveys, an array of geophones is used to detect reflections from subsurface earth formations of acoustic signals which are generated at, or near to, the surface of the earth. Geophysicists planning seismic surveys determine the positions where geophones are to be placed during a survey, normally on the earth's surface but commonly also in boreholes. These positions are known as stations, and one or more interconnected geophones may be placed at these stations. Such a collection of interconnected geophones is referred to as a geophone group, even if it consists of a single geophone.

The output of a geophone group is an analogue signal which is required to be digitized by a high-precision 24-bit analogue-to-digital converter to facilitate the high fidelity recording of the signal. As the geophone groups are typically distributed over a wide geographical area, it has become a common technique to deploy digitizer units containing between one and eight analogue-to-digital converters across the survey area, and to interconnect these digitizing units using cable to create a data transport network to transfer the digitized geophone signals to the data recorder.

Wireless systems have also come into use, as has the use of optical fibre cable to handle high data transfer rates. These developments, together with improved data processing, have allowed the use of larger seismic spreads and higher resolutions.

In our U.S. Pat. No. 6,219,620 (=EP 0934538) there is described a seismic acquisition system in which the terrain is divided into cells, and digitizer units within each cell communicate with a cell controller by wireless techniques. The cell controllers then communicate with a central control unit by wireless or fibre optic cable. Such an arrangement greatly reduces the amount of work required to set up the seismic spread, and also allows a large amount of data to be processed virtually in real time. However, wireless systems may be disrupted by poor signal paths, by other wireless equipment operating in similar frequencies, and even by movement of vegetation or animals. Moreover, such disruption may occur intermittently in the course of a survey.

This is particularly a problem with digitizer units located near the edge of cells, or which are in locations having poor radio propagation due to terrain or vegetation cover. These are often subject to intermittent communication, which slows down the data acquisition process and in more severe cases may lead to data from that unit being lost. The present invention seeks to overcome these problems.

### SUMMARY

The invention provides a method of acquiring seismic data from an array of geophone groups, each geophone group comprising one or more geophones connected to an acquisition unit; the method comprising:

passing data from the geophone group to the acquisition unit;

converting said data, if in analogue form, into digital form;

holding said data in a buffer store; and

transmitting said data to a central control unit;

and in which the digital data is additionally stored in a bulk, non-volatile store in the acquisition unit.

Another aspect of the invention provides an acquisition unit for use in seismic surveying, comprising:

input means for providing digitised geophone data to a temporary buffer;

transmission means for transmitting data from the buffer to a central control unit; and

a non-volatile bulk store connected to receive and store all digitised data provided by the input means.

A further aspect of the invention resides in a seismic data acquisition system comprising:

a plurality of acquisition units in accordance with the preceding paragraph;

a central control unit including a data recorder; and

a network interconnecting the central control unit and the acquisition units.

Preferred features and advantages of the invention will be apparent from the following description and claims.

### BRIEF DESCRIPTION OF THE DRAWINGS

An embodiment of the invention will now be described, by way of example only, with reference to the drawings, in which:

FIG. 1 is a schematic overview of a seismic survey system;

FIG. 2 shows part of the system in more detail; and

FIG. 3 is a block diagram of one remote acquisition unit in the system.

### DETAILED DESCRIPTION OF THE PREFERRED EMBODIMENT

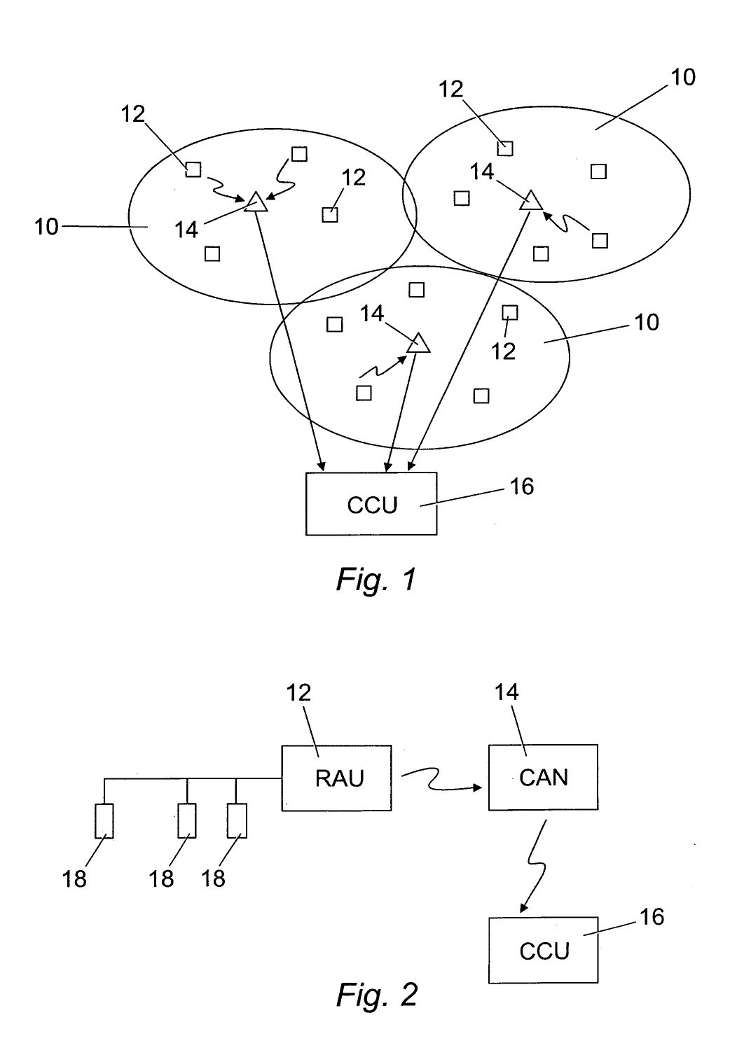

Referring to FIG. 1, a seismic survey terrain is divided into a number of cells 10. Each cell 10 contains a number of remote acquisition units (RAUs) 12 which communicate by wireless techniques with a cell access node (CAN) 14. The CANs 14 in turn communicate with a central control unit (CCU) 16; this communication may be wireless or by means of a fibre optic backbone.

Turning to FIG. 2, each of the RAUs 12 is connected to a single geophone group 18. Typically, the geophone signal is communicated in analog form to the RAU 12 and digitised within the RAU 12. Alternatively, the geophone 18 could be a digital geophone which transfers digital signals to the RAU by cable or by wireless. It is also possible for each geophone to be combined with its own RAU.

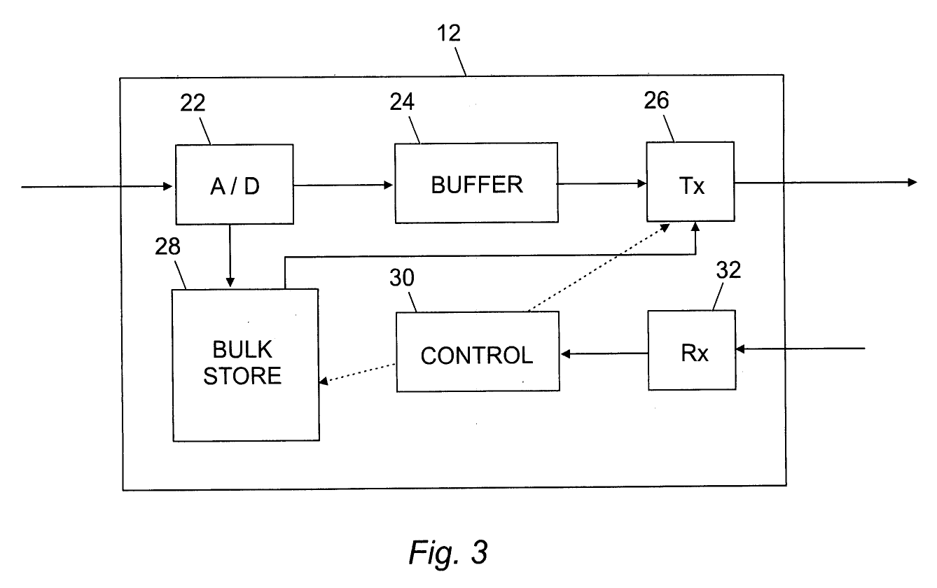

FIG. 3 illustrates one RAU 12. Incoming geophone signals are digitised by A/D converter and passed to a buffer 24. The buffer 24 provides a limited amount of short term storage, and provides for the digital data to be formed into packets which are transmitted by transmitter 26 when the RAU 12 is polled by the CCU 16.

The digitised signals are also passed to a non-volatile, bulk data store 28 which may suitably be in the form of a NAND flash device or a micro hard disk device. All data from the A/D converter 22 is stored in the store 28 until the latter is full, after which the oldest data is erased and replaced by the newest data. A 2 Gbit NAND flash device, for example, would be able to store approximately 40 hours of continuously acquired data at a 2 ms sample interval.

The RAU 12 also comprises a control circuit 30 and a receiver 32. In normal operation, the control circuit 30 will receive polling commands via the receiver 32, and in response will cause the transmitter 26 to transmit the data packet held in the buffer 24 to the CAN 14 and thence to the CCU 16 for recording.

Data can be extracted from the non-volatile store 28 in a random-access manner at any time. Thus the RAU 12 can additionally operate in the following modes:

1. In the event of the radio signal fading, the RAU 12 can continue to store acquired data in the bulk data store 28 until the radio connection is restored, at which time all outstanding data can be transferred.

2. In the event of a fault in the data network which causes data transmission between the RAU 12 and the CCU 16 to be subject to error or loss, the CCU 16 can at a later time instruct the RAU 12 to re-transmit the data. As all the data is still in the bulk store 28, the necessary data can be retrieved and re-transmitted.

3. In the event of a fault in the data network which causes data transmission between the RAU 12 and the CCU 16 to be subject to error or loss, the RAU 12 can re-transmit the data at a later time under its own control, when the RAU 12 detects that communications have been re-established and the CCU 16 is ready to accept data. As all the data is still in the bulk store 28, the necessary data can be retrieved and re-transmitted.

4. In the event of the RAU 12 failing to establish contact after power-up and performing internal tests, or in the event of the RAU 12 permanently losing contact with the CCU 16, the RAU 12 is able to autonomously acquire and store data continuously without loss of any data (until the bulk store 28 is full).

In the case of 4 above, a portable, short range CAN with its own hard disk can be used to collect data from any RAU's affected in this way, the portable CAN being transported to the CCU 16 for uploading such data. Alternatively, the portable CAN may transmit the data to the CCU 16 by means independent of the main transmission network, for example by a point-to-point radio link; or by transporting the portable CAN to a location having good access to the main transmission network.

The invention has been illustrated in terms of geophones which provide an analogue output which is subsequently digitized. It will be apparent that the invention may equally be used with geophones which each provide a direct digital output. Moreover, the term “geophone” is generally used to denote a sensor which principally senses displacement. Seismic sensors are also known which sense acceleration rather than displacement; the invention can equally be used with such accelerometer-type sensors, and the term “geophone” is used herein and in the claims to include such accelerometer-type sensors.

Although described with particular reference to a cellular wireless system, the invention may be applied to any seismic acquisition system which includes radio links.

1. A method of acquiring seismic data from an array of geophone groups, each geophone group comprising one or more geophones connected to an acquisition unit; the method comprising:
passing data from the geophone group to the acquisition unit;
converting said data, if in analogue form, into digital form;
holding said data in a buffer store; and
transmitting said data to a central control unit;
and in which the digital data is additionally stored in a bulk, non-volatile store in the acquisition unit.

2. The method of claim 1, in which, in the event of failure or error in the data transmission network, the central control unit causes selected data to be retrieved from the bulk store and re-transmitted.

3. The method of claim 1, in which, in the event of non-establishment or loss of the data transmission network, data is retrieved locally from the acquisition unit for transportation or independent forwarding to the central control unit.

4. An acquisition unit for use in seismic surveying, comprising:
input means for providing digitised geophone data to a temporary buffer;
transmission means for transmitting data from the buffer to a central control unit; and
a non-volatile bulk store connected to receive and store all digitised data provided by the input means.

5. An acquisition unit according to claim 4, in which the input means comprises an analogue-to-digital converter for digitizing analogue data received from a geophone group.

6. An acquisition unit according to claim 4, in which said bulk store comprises a NAND flash memory or a mini hard disk.

7. An acquisition unit according to claim 4, including control means responsive to commands from a central control unit to retrieve selected data from the bulk memory and re-transmit the retrieved data.

8. A seismic data acquisition system comprising:
a plurality of acquisition units in accordance with claim 4;
a central control unit including a data recorder; and
a network interconnecting the central control unit and the acquisition units.

9. A system according to claim 8, in which said network comprises a series of cells, the acquisition units in each cell communicating wirelessly with a cell access node, and the cell access nodes communicating with the central control units.

10. The system of claim 8, in which data is transmitted from the buffer of each acquisition unit in response to polling signals from the central control unit.
